(19) United States
(12) Patent Application Publication
(10) Pub. No.: US 2004/0256812 A1
(43) Pub. Date: Dec. 23, 2004

(54) Combination seal and bearing unit

(76) Inventor: Hiroshi Terazawa, Okayama (JP)

Correspondence Address: BACON & THOMAS, PLLC, 625 SLATERS LANE, FOURTH FLOOR, ALEXANDRIA, VA, 22314

(21) Appl. No.: 10/815,940

(22) Filed: Apr. 2, 2004

(30) Foreign Application Priority Data
Apr. 4, 2003 (JP) 2003-101416

(51) Int. Cl. F16J 15/34

(52) U.S. Cl. 277/549

(57) ABSTRACT

A combination seal composed of a separately mounted first annular case and second annular case with an annular seal member provided with protruding lips. With this seal, there is no backward bending of the radial lip, seal design is facilitated, and the seal can be miniaturized. In the combination seal with the first annular case fitted on an inner ring, and the second annular case fitted in an outer ring and provided with an annular seal member that has lips sealingly engaging the first annular case, the first annular case is shaped as a cylinder having the fitting cylindrical portion fitted on the inner ring, and a first vertical wall extending toward the fitting cylindrical portion of the second case, and the annular seal member is provided with protruding axial lips whose distal portions are in sealing engagement with the first vertical wall, and a protruding radial lip whose distal portion is in sealing engagement with the external peripheral surface of the inner ring. The radial lip is shaped such that the distal portion thereof is inclining farther away than its leg portion from the first vertical wall of the first annular case in a direction along with the inner ring.

### BACKGROUND OF THE INVENTION

1. Field of the Invention

The present invention relates to a combination seal referred to as a so-called “pack seal,” and a bearing unit provided therewith, and more specifically to an improvement for a combination seal comprising the first annular case, and the second annular case having an annular seal member provided with protruding lips sealingly engaging the first annular case, these cases being fitted separately in and /on a stationary member and a rotatable member.

2. Description of the Related Art

In prior art, combination seals are commonly used in a bearing unit that rotatably supports an automobile wheel. In other words, the bearing unit comprises an inner ring inside the hub, which is a rotatable member, an outer ring outside the hub carrier, which is a stationary member, and two left and right rows of balls that are interposed between both rings; and a combination seal is provided on one or both of the space between the hub carrier and the hub in the front of the row of the balls. An example of such a configuration is disclosed in JP-A-2002-349576.

Describing the structure of a conventional combination seal, a combination seal S is configured with the first annular case 23 that is externally fitted on an inner ring 21, which is a rotatable member, and the second annular case 24 that is internally fitted in the outer ring 22, which is a stationary member, in a state in which an annular seal member 25 is integrally mounted, as shown in FIG. 5. The first annular case 23 is an L-shaped cross-section plate metal element of which has the first fitting cylindrical portion 23A that is externally fitted on the inner ring 21, and has the first vertical wall 23B that is bent at the edge portion thereof and stands erect toward the outer ring 22.

The second annular case 24 is a roughly L-shaped cross-section plate metal element of which has the second fitting cylindrical portion 24A that is internally fitted in the outer ring 22, and has the second vertical wall 24B that is bent at the edge portion thereof and stands erect toward the inner ring 21. The seal member 25, integrated with the second annular case 24 by bonding, has two axial lips 25a and 25b the distal portions of which sealingly engage the first vertical wall 23B, and a single radial lip 25c the distal portion of which sealingly engages the first fitting cylindrical portion 23A, for a total of three lips.

FIG. 6 shows another structure of a conventional combination seal. This seal has a seal member 26 that is formed with a single axial lip 26a, and two radial lips 26b and 26c in sealing engagement with the first fitting cylindrical portion 23A, but the structure is otherwise essentially the same as the one depicted in FIG. 5. When these two seals are compared, the dual axial lip-type seal depicted in FIG. 5 has superior dust resistance and low torque resistance, and the dual radial lip-type seal depicted in FIG. 6 has the ability to reduce the seal space in the internal-external radial direction, but the seals are limited in the sense that they must be assembled with the bearings in a state in which the seal member 26 and a slinger 23 (second annular case 24 and first annular case 23) are packed together (incorporated into each other).

The above-described bearing unit doubles as a bearing designed with members that constitute a wheel and supporting elements thereof, and is used as a means so as to reduce the number of components or to reduce the weight, and the like by endowing the members with multiple functions. But in recent years structures with even greater multifunctional capabilities have come to be occasionally used. These are bearing unit structures that are referred to as “the fourth generation hub bearings,” and they involve such techniques that an intermediate joint mechanism for joining rotatablely an inner ring 1 and an outer ring body 14 can be omitted, by joining the outer ring body 14, which is a constituent member of a constant velocity joint 5, directly to the inner edge side of an inner ring 2, as shown in FIG. 1, and efficiency can be further enhanced.

However, it has become apparent that the combination seal according to either of the prior arts described above is not suitable for this type of bearing unit. The reasons for this are described below. In other words, according to the structure depicted in FIG. 1, an outer ring body 14 is integrally mounted on a hub 2 by a crimping operation whereby the distal end portion of an inner cylindrical portion 2a is plastically extended in a state in which an input cylindrical portion 6, integrally provided with an inner ring portion 7 for balls 9 in the crosswise direction of the vehicle chassis, is press-fitted over the inner cylindrical portion 2a of the hub 2.

Therefore, as an assembly of an inner combination seal S internally disposed in the crosswise direction of the vehicle chassis, the first annular case 17 and the second annular case 19 are respectively press-fitted to the inner ring portion 7 and the hub carrier 4 in advance, and the annular cases 17 and 19 are set in a predetermined relative positional relationship by fitting the inner ring portion 7 to the inner cylindrical portion 2a to yield one possible mode for the combination seal S. Thus, the dimensional accuracy of both the first and second annular cases 17 and 19 is provided indirectly via the inner ring portion 7, causing the relative positional accuracy of both annular cases 17 and 19, that is, the relative positional accuracy along the direction of rotation, to decrease in comparison with the case in which the annular cases 17 and 19 are simultaneously press-fitted and set with a single machining operation, as in the prior art.

Following is a rough description of an operation in which a conventionally known combination seal S is press-fitted and set. Two annular cases 23 and 24 are pressed into the space between the inner and outer rings 21 and 22 at the same time by way of a ring-shaped press-fitting jig J, which is brought into contact with the side surface of the first vertical wall 23B of the first case 23 and the end face of the fitting cylindrical portion 24A of the second annular case 24, as shown in FIG. 8, so the relative positions in the axial direction of the annular cases 23 and 24 are set between the inner and outer rings 21 and 22 in a state in which good precision is maintained by the single press-fitting jig J.

For this reason, in the prior-art seal shown in FIG. 5, the dimensional error increases in the axial direction, so the length of the axial lip itself and the spacing in the axial direction between the first and second annular cases must be increased in order to ensure adequate sealing action in the axial direction even if the relative positions of the outer cases in the axial direction vary due to press-fitting, and the axial length of the entire seal is increased. In addition, the axial lip is set at an incline in order to sealingly engage the first vertical wall, so the dimension in the radial direction must be increased because of the increased radial variability of the relative positions of the axial lip and the first vertical wall. A resulting drawback is that the combination seal shown in FIG. 5 tends to increase in size in the axial and radial directions in order to be applicable to a “the fourth generation hub bearing.”

Also, the prior-art seal shown in FIG. 6 has a drawback in that the first radial lip reverses direction as the combination seal is being assembled. In other words, describing this effect with reference to the schematic assembly operation diagrams shown in FIG. 7, the inner ring portion 7 is first slid relative to the outer ring 22 in which the second annular case 24 is mounted, and is fitted into the inner cylindrical portion 2a on which the first annular case 23 is mounted, as shown in FIG. 7a. The inclination of the first radial lip 26b then becomes opposite to the direction of advance of the first case 23 during sliding, the lip is pressed against the end portion of the first fitting cylindrical portion 23A of the first annular case 23, as shown in FIG. 7b, and the first radial lip 26b reverses direction (flips) when the first annular case 23 is inserted and set in the proper position, as shown in FIG. 7c, resulting in a structure that does not serve its purpose.

### SUMMARY OF THE INVENTION

An object of the present invention is to provide a combination seal that overcomes the drawbacks of each type of combination seal as described above, and demonstrates good sealing function without reversing the direction of the radial lip or resulting in larger seal dimensions even in a bearing unit whose structure entails an order of assembly in which the first annular case is mounted on the second annular case.

According to the first aspect of the present invention, there is provided a combination seal comprising the first annular case, and the second annular case having an annular seal member provided with protruding lips sealingly engaging the first annular case, these cases being fitted separately in and/or on a stationary member and a rotatable member, wherein the first annular case is shaped as a cylinder having a fitting cylindrical portion fitted in and/or on one of the members of the stationary member and the rotatable member, and the first vertical wall that extends toward the fitting cylindrical portion and is fitted in and/or on the other member of the stationary member and rotatable member; the annular seal member is provided with protruding axial lips having the distal portions which sealingly engage the first vertical wall of the first annular case, and a protruding radial lip having the distal portion which sealingly engages the external peripheral surface of the rotatable member; and wherein the radial lip extends such that its distal portion that sealingly engages the external peripheral surface of the rotatable member is inclining farther away than its leg portion thereof from the first vertical wall in a direction along with the rotatable member.

According to the first aspect, the distal portion that sealingly engages the peripheral surface is inclined so as to be positioned farther away from the first vertical wall than the leg portion of the radial lip, so even if, for example, the inner ring fitted with the first annular case is subsequently assembled with the outer ring fitted with the second annular case, the direction in which the radial lip is slidably pulled is the same as the lip inclination when the radial lip is slidably pulled during the movement of the inner ring being assembled because the movement direction of the inner ring and the inclination of the radial lip coincide with each other, and the radial lip can be installed without reversing direction.

Because the radial lip has a structure that sealingly engages the peripheral surface to which the first annular case in the stationary or rotating member is fitted, the combination seal has design advantages in that the seal space can be made wider by the radial thickness of the fitting cylindrical portion in comparison with the case in which the radial lip sealingly engages the fitting cylindrical portion of the first annular case, and the desired sealing characteristics can be readily ensured. This is because the tolerance for accommodating the axial lip in the axial direction can be made wider, making it possible to enhance the space flexibility of the axial lip in the radial direction. It also becomes possible to reduce the radial or crosswise dimension of the seal by the thickness of the fitting cylindrical portion in the radial direction.

As a result, an efficiently designed combination seal can be provided in which the radial lip does not bend backward during assembly and the design freedom can be expanded and the seal dimensions can be reduced by the expanded seal space even in the above-described “the fourth generation hub bearing” and in other situations in which it is impossible to assemble the first and second annular cases at the same time.

According to the second aspect, the axial lips of the first aspect are formed as two lips, and the radial lip is formed as a single lip.

According to the second aspect, there is provided a combination seal having two axial lips and excellent dust resistance, and this combination seal is therefore suitable for use in a bearing unit with left and right seals for supporting an automobile wheel as a seal that is disposed on the outside and tends to be exposed to mud and dust because of the absence of a wheel to the side, or as a combination seal disposed at other locations in which dust resistance is required.

According to the third aspect, the stationary member and the rotatable member of the first or second aspect are inner and outer rings respectively that constitute a bearing; and the first annular case is fitted on the rotatable member.

According to the third aspect, a structure is provided in which the inner ring corresponds to a hub 2, which is the rotatable member; the outer ring corresponds to a carrier 4, which is the stationary member; and the first annular case 17 is fitted on the hub 2, as shown, for example in FIG. 2; this configuration is suitable as an automobile wheel support structure; and the first annular case, which can be made lighter than the second annular case, is disposed on the rotatable member, making it possible to reduce rotational resistance and other types of inertia associated with rotation.

According to the fourth aspect, there is provided a bearing unit having bearing members interposed between a rotatable member and a stationary member in order to allow the rotatable member to rotate relative to the stationary member, wherein the combination seal according to any of the first to third aspects is provided at a location outside of the bearing members.

According to the fourth aspect, a combination seal in which no functional impediments exist even with the separate assembly of the first and second annular cases is mounted on the outside of the bearing members between a stationary member and a rotatable member, so the above-described “the fourth generation hub bearing” or another bearing unit with a structure in which the first and second annular cases cannot be simultaneously assembled can be provided with an excellent seal function by way of a combination seal.

### BRIEF DESCRIPTION OF THE DRAWINGS

FIG. 1 is a cross-sectional view depicting a bearing unit and peripheral structure for an automobile;

FIG. 2 is an enlarged cross-sectional view of the principal components depicting the structure of a combination seal;

FIG. 3 shows a process diagram depicting the state in which the combination seal is assembled;

FIG. 4 is a cross-sectional view depicting a combination seal with another structure;

FIG. 5 is a cross-sectional view depicting the first conventional combination seal;

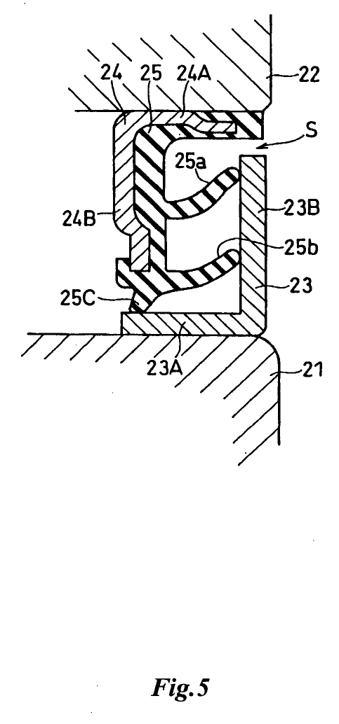

FIG. 6 is a cross-sectional view depicting the second conventional combination seal;

FIGS. 7a to c are process diagrams depicting the assembly of the combination seal of FIG. 6; and

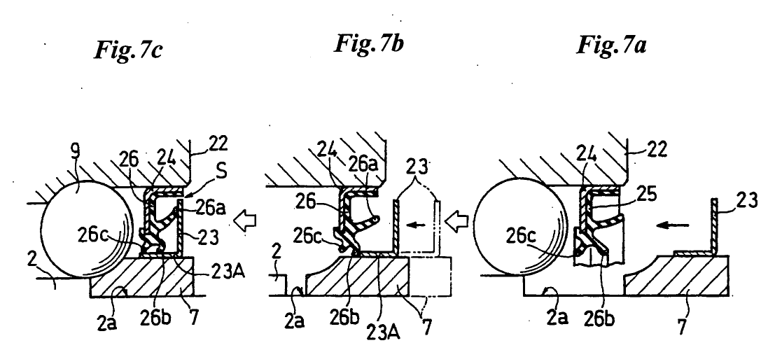

FIG. 8 is a process diagram depicting the operation of setting a conventional combination seal by press fitting.

### DESCRIPTION OF THE PREFERRED EMBODIMENTS

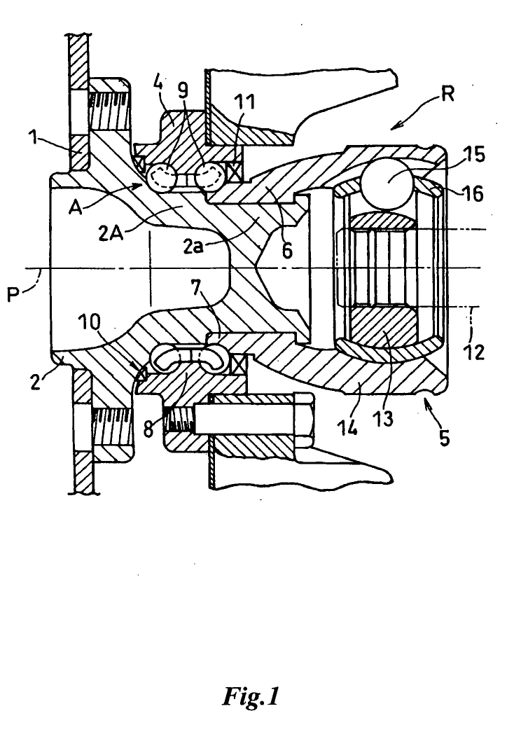

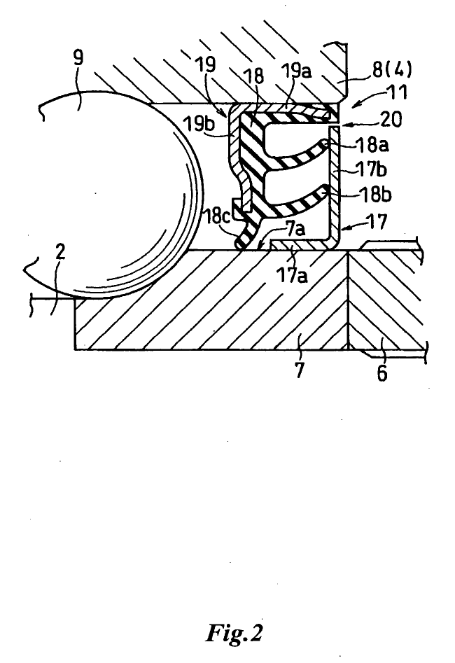

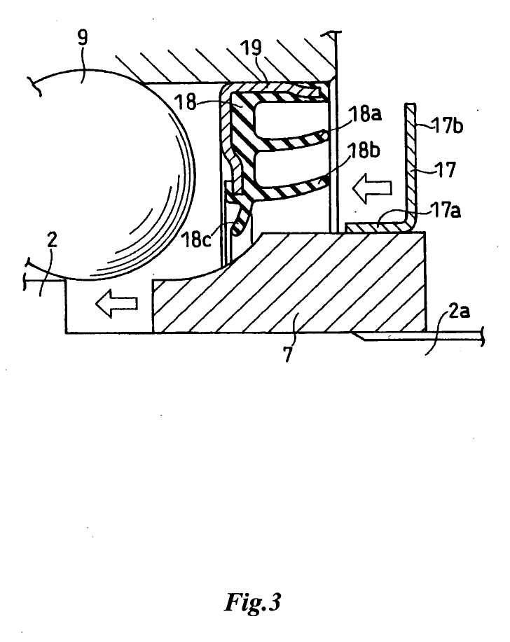

Embodiments of the present invention are described below with reference to the diagrams. FIG. 1 shows a bearing unit A that functions as an angular bearing for rotatably supporting the tires or other drive wheels (front wheels in a front-engine, front-drive vehicle; rear wheels in a front-engine, rear-drive vehicle; or the like) of an automobile, and also shows the peripheral structure, or the suspension structure R referred to as “the fourth generation hub bearing.” FIG. 2 is an enlarged cross-sectional view of the combination seal portion disposed on the inner side, which is the internal side in the crosswise direction of the vehicle chassis; and FIG. 3 shows a process diagram depicting the state in which the combination seal is assembled.

The suspension structure R has a hub 2 on which a wheel 1 with a tire is mounted with bolts, a hub carrier 4 fixed with bolts to a support member 3 on the vehicle chassis side, and a constant velocity joint 5 joined in an interlocking manner to the inside end of the hub 2, as shown in FIG. 1. The bearing unit A has an external inner ring portion 2A integrally formed on the hub 2, an internal inner ring portion 7 fitted on the hub 2, an outer ring portion 8 integrally formed on the hub carrier 4, and a plurality of balls 9 interposed in two left and right rows between these. Seals 10 and 11 are provided between the outer ring portion 8 and the inner ring portions 2A and 7 in the front of the rows of the balls 9.

The constant velocity joint 5 is a known device having an inner ring body 13 to which a drive shaft 12 is fitted in an integrally rotatable manner, an outer ring body 14 fitted in the hub 2 in an integrally rotatable manner, a retainer 16 for holding balls 15 designed for transmitting torque and interposed between the ring bodies 13 and 14, and other components.

The internal inside ring portion 7 is fitted and mounted by press-fitting in the inner cylindrical portion 2a of the hub 2, and an input cylinder 6 is fitted in an integrally rotatable manner by spline coupling to the inside thereof. The internal inside ring portion 7 and input cylinder 6 are irremovably mounted on the hub 2 by the above-described crimping operation whereby the innermost end portion of an inner cylindrical portion 2a is extended. Outer ring body 14 of the constant velocity joint 5 is removably spline-fitted on the input cylinder 6.

Seal 11, which is one of the left and right seals 10 and 11 and which is positioned on the inside in the crosswise direction of the vehicle chassis, is described next. The inner seal 11 is configured with a combination seal (so-called “pack seal”) comprising the first annular case 17 press-fitted on the internal inner ring portion (an example of the rotatable member) 7, and the second annular case 19 press-fitted in the outer ring portion (an example of the stationary member) 8 and provided with an annular seal member 18 that has integrally formed lips 18a and 18b in sealing engagement with the first annular case 17, as shown in FIGS. 2 and 3.

The first annular case 17 is shaped as a cylinder having the first vertical wall 17b protruding toward the fitting cylindrical portion 19a of the second annular case 19 extends from a fitting cylindrical portion 17a externally fitted on the internal inner ring portion 7, and the second annular case 19 is shaped as a cylinder in which the second vertical wall 19b protruding toward the fitting cylindrical portion 17a of the first annular case 17 extends from the fitting cylindrical portion 19a that is fitted in the outer ring portion 8. The seal member 18 has two axial lips 18a and 18b the distal portions of which sealingly engage the first vertical wall 17b, and one radial lip 18c having the distal portion which sealingly engages the external peripheral surface (an example of the peripheral surface in and/or on which the first annular case in the rotatable member or the stationary member is fitted) 7a of the internal inner ring portion 7. Furthermore, a predetermined gap is set between the end face that is the outermost radial portion of the first vertical wall 17b, and the internal peripheral surface of the portion around the distal end of the fitting cylindrical portion 19a in the seal member 18 to form a labyrinth portion 20 as a noncontact mechanical seal.

The two axial lips 18a and 18b are inclined a free state (a state in which nothing is in contact with the lips) in the direction in which the distal portions come closer to the outer ring portion 8 than its leg portion thereof (see FIG. 3). The radial lip 18c is inclined in the above-described free state such that the distal portion in contact with the external peripheral surface 7a of the internal inside portion 7 is farther away from the first vertical wall 17b than its leg portion in a direction (direction of the axial center P) along with the hub 2. That is to say, the radial lip 18c is inclined the direction in which its distal portion thereof is closer inward in the crosswise direction of the bearing unit A than its leg portion.

In the structure of the bearing unit A, the first annular case 17 is moved toward the second annular case 19 already fitted in the outer ring portion 8, and is set in the proper relative position because the internal inner ring portion 7 already fitted with the first case 17 is press-fitted on the inner cylindrical portion 2a of the hub 2, as shown in FIG. 3, where the assembled state of the combination seal 11 is depicted. At this time, the internal inner ring portion 7 that is moving outward in the crosswise direction of the vehicle chassis slidably pulls the radial lip 18c, the radial lip 18c is slidably pulled in a free state in the same direction because the distal portion thereof faces outward in the crosswise direction of the vehicle, as described above, and assembly can be achieved without any problems (without backward bending or overturning of the lip as in the prior art).

The combination seal 11 with above-described structure is advantageous. Namely because the radial lip 18c is in direct sealing engagement with the external peripheral wall 7a of the internal inner ring portion 7, a gap equivalent to the plate thickness of the fitting cylindrical portion 17a of the first annular case 17 can be created. Consequently the design freedom where the desired sealing characteristics can easily be provided by expansion of the seal-forming space is acquired, or the seal diameter can be reduced by the portion equivalent to the plate thickness.

### Other Embodiments

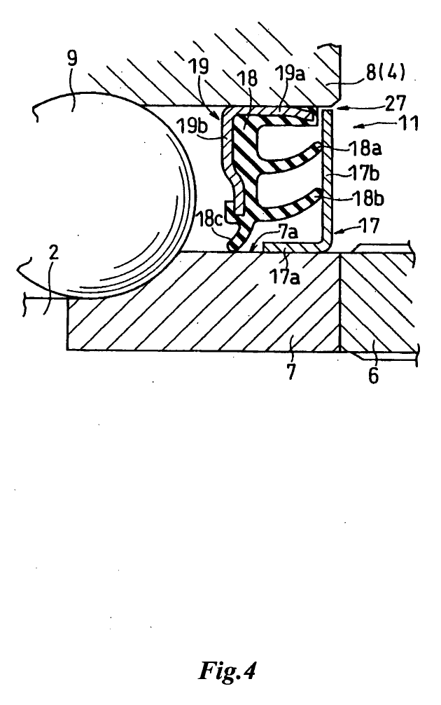

(1) Another option is a structure in which the first vertical wall 17b of the first annular case 17 is disposed closer outward along the rotational axis P of the internal inner ring portion 7 than the end face of the fitting cylindrical portion 19a of the second annular case 19, as shown in FIG. 4. In other words, the fitting cylindrical portion 19a of the second annular case 19 is slightly shortened in comparison with the combination seal 11 shown in FIG. 2, the distal portion farther away from the first vertical wall 17b in the radial direction is extended to a position approaching the internal peripheral surface of the outer ring portion 8, and an L-shaped labyrinth portion 27 with a cross-sectional shape is formed. The structure is otherwise the same as the one shown in FIG. 2.

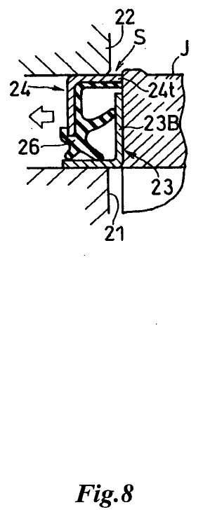

When assembly is performed with the annular cases 17 and 19 set in advance (see FIG. 8), a press-fitting force must be directly applied for assembly to the second annular case 19, so a structure in which the end face of the fitting cylindrical portion 19a protrudes to the outermost side must commonly be adopted, but because such restrictions can be overcome in accordance with the present invention by using a structure in which the annular cases 17 and 19 are assembled separately, the first vertical wall 17b can be allowed to protrude further outward from the end face of the fitting cylindrical portion 19a. A resulting advantage is that a labyrinth portion 27 with a curved path is set, as shown in FIG. 4, passage of dust is impeded, and the sealing characteristics can be further improved.

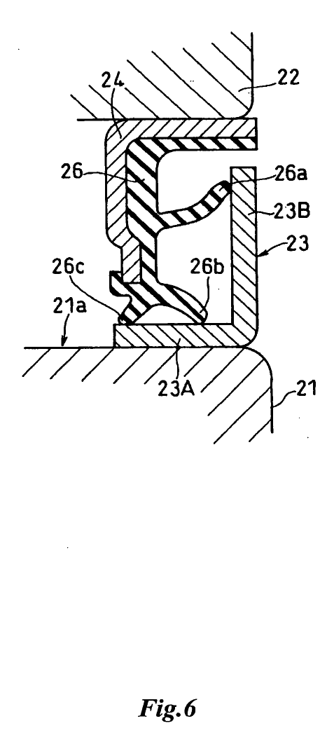

(2) The present invention may also be applied to a combination seal comprising the second annular case 19 and the first annular case 17 that are respectively fitted in and/or on an inwardly disposed inner ring portion 7 and an outer ring portion 8, or to a combination seal comprising the first and second annular cases 17 and 19 that are separately fitted in and/or on the inner ring of a stationary member and the outer ring of a rotatable member, respectively. Although not depicted, the present invention may be applied to a combination seal (a seal such as the one shown in FIG. 6) configured to have a seal member with one axial lip and two radial lips. In the combination seal according to the present invention, the first and second annular cases can be integrally assembled in a bearing (between the rotatable member and the stationary member) in the same manner as in the prior art.

As described above, according to the combination seal of the present invention, the first annular case is shaped as a cylinder in which the first vertical wall protruding toward the fitting cylindrical portion of the second annular case extends from a fitting cylindrical portion fitted in a hub as an inner ring, which is a rotatable member; a seal member having two axial lips the distal portions of which sealingly engage the first vertical wall, and also having a single radial lip the distal portion of which sealingly engages the external peripheral surface of an internal inner ring portion, is provided to the second annular case; and the radial lip is inclined in a direction in which its distal portion that sealingly engages the external peripheral surface of the internal inner ring is positioned farther away than its leg portion thereof from the first vertical wall.

As a result, an efficiently designed combination seal can be provided in which the radial lip does not reverse direction during assembly, design freedom is enhanced by increasing the seal space, and the seal dimensions can be reduced even in suspension structures in which the hub and hub carrier double as constituent members of the bearing, and in which a constant velocity joint is joined in an interlocking manner to the inside end of the hub, such as in the above-described “the fourth generation hub bearings,” and in other situations in which the first and second annular cases cannot be simultaneously assembled. A structure with two axial lips may also be used to further enhance dust resistance.

What is claimed is:

1. A combination seal comprising a first annular case, and a second annular case having an annular seal member provided with protruding lips sealingly engaging said first annular case, said annular cases being fitted separately in and/or a stationary member and a rotatable member, wherein
said first annular case is formed of a cylinder having a fitting cylindrical portion fitted in and/or one of the members of the stationary member and the rotatable member, and the first vertical wall that extends toward the fitting cylindrical portion of the other member of the stationary member and rotatable member;
said annular seal member is provided with protruding axial lips having a distal portion which sealingly engages said first vertical wall of said first case, and a protruding radial lip having a distal portion which sealingly engages the external peripheral surface of said rotatable member; and wherein
said protruding radial lip extends such that its distal portion which sealingly engages said external peripheral surface of said rotatable member is inclining farther away than its leg portion from said first vertical wall of said first annular case in a direction along with said rotatable member.

2. The combination seal according to claim 1, wherein said axial lips are formed as two lips, and said protruding radial lip is formed as a single lip.

3. The combination seal according to claim 1, wherein said stationary member and said rotatable member are inner and outer rings respectively that constitute a bearing; and
said first annular case is fitted in said rotatable member.

4. A bearing unit having bearing members interposed between a rotatable member and a stationary member in order to allow the rotatable member to rotate relative to the stationary member, wherein
the combination seal according to any of claims 1 is provided at a location outside of the bearing members.
